(19) United States
(12) Patent Application Publication
(10) Pub. No.: US 2021/0218286 A1
(43) Pub. Date: Jul. 15, 2021

(54) WIRELESS WATCH CHARGING STAND AND STANDBY CIRCUIT

(71) Applicant: AIRA, INC., Chandler, AZ (US)

(72) Inventors: Eric Heindel Goodchild, Phoenix, AZ (US); Camron Vossberg, Tempe, AZ (US); Jake Slatnick, San Diego, CA (US)

(21) Appl. No.: 17/141,056

(22) Filed: Jan. 4, 2021

Related U.S. Application Data
(60) Provisional application No. 62/958,719, filed on Jan. 9, 2020.
(60) Provisional application No. 63/118,004, filed on Nov. 24, 2020.

(51) Int. Cl. H02J 50/50; H02J 7/02; H02J 50/12; H02J 7/00; H02J 50/90; H02J 50/40; H02J 7/34; H02J 50/00

(52) U.S. Cl. CPC H02J 50/50; H02J 7/02; H02J 50/12; H02J 7/0044; H02J 2207/50; H02J 50/402; H02J 7/345; H02J 7/342; H02J 50/005; H02J 50/90

(57) ABSTRACT

A charging stand placeable on a charging surface has a receiver circuit in a base configured to receive power from a wireless charging device through a receiving coil in the base. A support of the charging stand has a transmitting coil configured to transmit power to a chargeable device mounted on the support, and a power transfer circuit receives an induced current from the receiving coil in the base and provides a charging current to the transmitting coil. An energy storage device is configured to receive the induced current or a rectified current. A transmitter circuit is configured to provide the charging current to the transmitting coil. A sensor is configured to detect whether the chargeable device is mounted on the support, and a controller may be configured to power-down the power transfer circuit when chargeable device is not mounted on the support.

### PRIORITY CLAIM

This application claims priority to and the benefit of provisional patent application No. 62/958,719 filed in the United States Patent Office on Jan. 9, 2020 and of provisional patent application No. 63/118,004 filed in the United States Patent Office on Nov. 24, 2020, the entire content of these applications being incorporated herein by reference as if fully set forth below in their entirety and for all applicable purposes.

### TECHNICAL FIELD

The present invention relates generally to wireless charging of batteries, including the use of a multi-coil wireless charging device to charge batteries in mobile devices regardless of location of the mobile devices on a surface of the multi-coil wireless charging device and the size of the mobile devices.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to support continually increasing complexity of mobile devices and changing form factors. For example, there is a need for improved charging techniques for multi-coil, multi-device charging pads.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates an example of an arrangement of charging cells when multiple layers are overlaid within a segment of a charging surface that may be adapted in accordance with certain aspects disclosed herein.

FIG. 4 illustrates the arrangement of power transfer areas provided by a charging surface that employs multiple layers of charging cells configured in accordance with certain aspects disclosed herein.

FIG. 5 illustrates a wireless transmitter that may be provided in a charger base station in accordance with certain aspects disclosed herein.

FIG. 6 illustrates a first topology that supports matrix multiplexed switching for use in a wireless charging device adapted in accordance with certain aspects disclosed herein.

FIG. 7 illustrates a second topology that supports direct current drive in a wireless charging device adapted in accordance with certain aspects disclosed herein.

FIG. 8 illustrates first configurations of a charging surface and chargeable device in accordance with certain aspects disclosed herein.

FIG. 9 illustrates second charging configurations on a charging surface when a chargeable device is being charged in accordance with certain aspects disclosed herein.

FIG. 10 illustrates a charging surface of a multi-device wireless charger provided in accordance with certain aspects disclosed herein.

FIG. 11 illustrates an example of a charging stand provided in accordance with certain aspects disclosed herein.

FIG. 12 illustrates circuits, 1220 than can be provided within the charging stand of FIG. 11.

FIG. 13 is a flowchart illustrating a method of charging in accordance with certain aspects disclosed herein.

FIG. 14 illustrates an example of a charging stand configured for standby power control in accordance with certain aspects disclosed herein.

FIG. 15 is a flowchart illustrating a power control method in accordance with certain aspects disclosed herein.

FIG. 16 is a flowchart illustrating a power transfer method in accordance with certain aspects disclosed herein.

FIG. 17 illustrates one example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Overview

Certain aspects of the present disclosure relate to systems, apparatus and methods applicable to wireless charging devices that provide a free-positioning charging surface that has multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

Certain aspects disclosed herein relate to improved wireless charging techniques. Systems, apparatus and methods are disclosed that accommodate free placement of chargeable devices on a surface of a multi-coil wireless charging device. Certain aspects can improve the efficiency and capacity of wireless power transmission to a receiving device. In one example, a wireless charging apparatus has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to a charging surface without overlap of power transfer areas of the charging cells in the plurality of charging cells.

According to certain aspects disclosed herein, power can be wirelessly transferred to a receiving device located anywhere on a charging surface that can have an arbitrarily defined size or shape without regard to any discrete placement locations enabled for charging. Multiple devices can be simultaneously charged on a single charging surface. The charging surface may be manufactured using printed circuit board technology, at low cost and/or with a compact design.

In one aspect of the disclosure, a charging stand has a support, a sensor and a controller. The support may be configured to mount a wearable device such that a transmitting coil in the support engages a receiving coil of the wearable device when the wearable device is mounted on the support. The sensor may be configured to detect whether the wearable device is mounted on the support. The controller may be coupled to the sensor and configured to power-down one or more circuits of the charging stand when the sensor indicates that the wearable device is not mounted on the support, and power-up the one or more circuits of the charging stand when the sensor indicates that the wearable device is mounted on the support.

In some examples, the charging stand has an energy storage device, and a charging circuit configured to generate a charging current when powered by the energy storage device. The controller may be configured to cause the charging circuit to provide the charging current to the transmitting coil after powering-up the one or more circuits of the charging stand. The charging stand may have a switch configured to couple the energy storage device to the charging circuit when the one or more circuits of the charging stand are powered-up. The energy storage device may include a battery. The energy storage device may include a capacitive storage device such as a supercapacitor. The energy storage device may be configured to receive a replenishing current when a power supply is coupled to the charging stand. The charging stand may have a wireless receiver circuit coupled to a receiving coil located in a base of the charging stand. The energy storage device may be configured to receive a replenishing current from the wireless receiver circuit when the charging stand is placed on a wireless charging device. The charging circuit may be operated in accordance with a first wireless charging protocol and the wireless receiver circuit is operated in accordance with a second wireless charging protocol are the same or are compatible with one another. The first wireless charging protocol may be different from the second wireless charging protocol. The first wireless charging protocol and the second wireless charging protocol may be the same or may be compatible with one another.

### Charging Cells

Certain aspects of the present disclosure relate to systems, apparatus and methods applicable to wireless charging devices that provide a free-positioning charging surface that has multiple transmitting coils or that can concurrently charge multiple receiving devices. In one aspect, a processing circuit coupled to the free-positioning charging surface can be configured to locate a device to be charged and can select and configure one or more transmitting coils that are optimally positioned to deliver power to the receiving device. Charging cells may be configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

According to certain aspects disclosed herein, a charging surface in a wireless charging device may be provided using charging cells that are deployed adjacent to the charging surface. In one example the charging cells are deployed in accordance with a honeycomb packaging configuration. A charging cell may be implemented using one or more coils that can each induce a magnetic field along an axis that is substantially orthogonal to the charging surface adjacent to the coil. In this disclosure, a charging cell may refer to an element having one or more coils where each coil is configured to produce an electromagnetic field that is additive with respect to the fields produced by other coils in the charging cell and directed along or proximate to a common axis. In this description, a coil in a charging cell may be referred to as a charging coil or a transmitting coil.

In some examples, a charging cell includes coils that are stacked along a common axis. One or more coils may overlap such that they contribute to an induced magnetic field substantially orthogonal to the charging surface. In some examples, a charging cell includes coils that are arranged within a defined portion of the charging surface and that contribute to an induced magnetic field within the defined portion of the charging surface, the magnetic field contributing to a magnetic flux flowing substantially orthogonal to the charging surface. In some implementations, charging cells may be configurable by providing an activating current to coils that are included in a dynamically-defined charging cell. For example, a wireless charging device may include multiple stacks of coils deployed across a charging surface, and the wireless charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

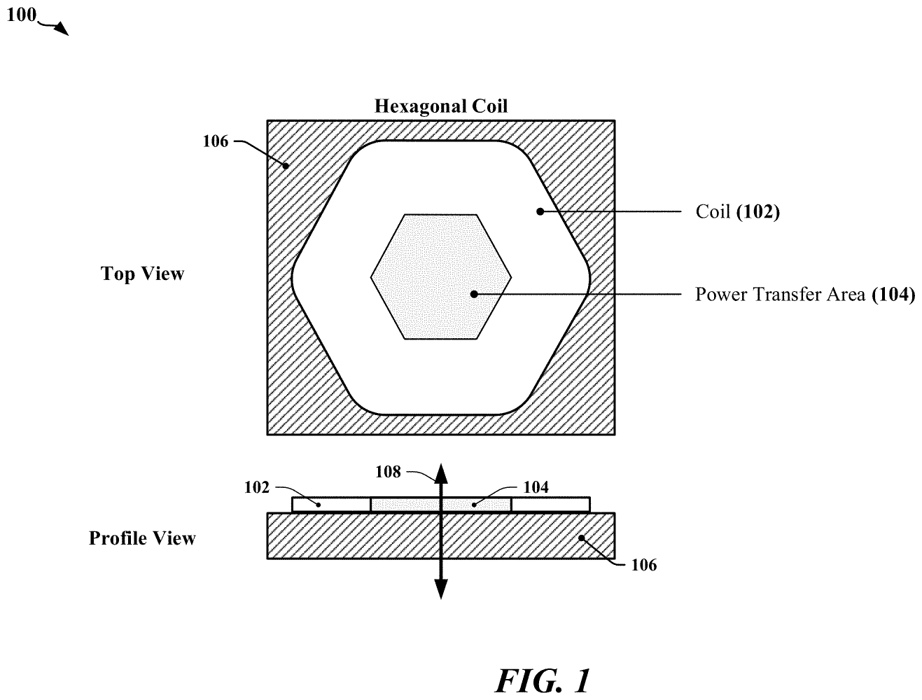

FIG. 1 illustrates an example of a charging cell 100 that may be deployed and/or configured to provide a charging surface in a wireless charging device. In this example, the charging cell 100 has a substantially hexagonal shape that encloses one or more coils 102 constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations may include or use coils 102 that have other shapes. The shape of the coils 102 may be determined at least in part by the capabilities or limitations of fabrication technology or to optimize layout of the charging cells on a substrate 106 such as a printed circuit board substrate. Each coil 102 may be implemented using wires, printed circuit board traces and/or other connectors in a spiral configuration. Each charging cell 100 may span two or more layers separated by an insulator or substrate 106 such that coils 102 in different layers are centered around a common axis 108.

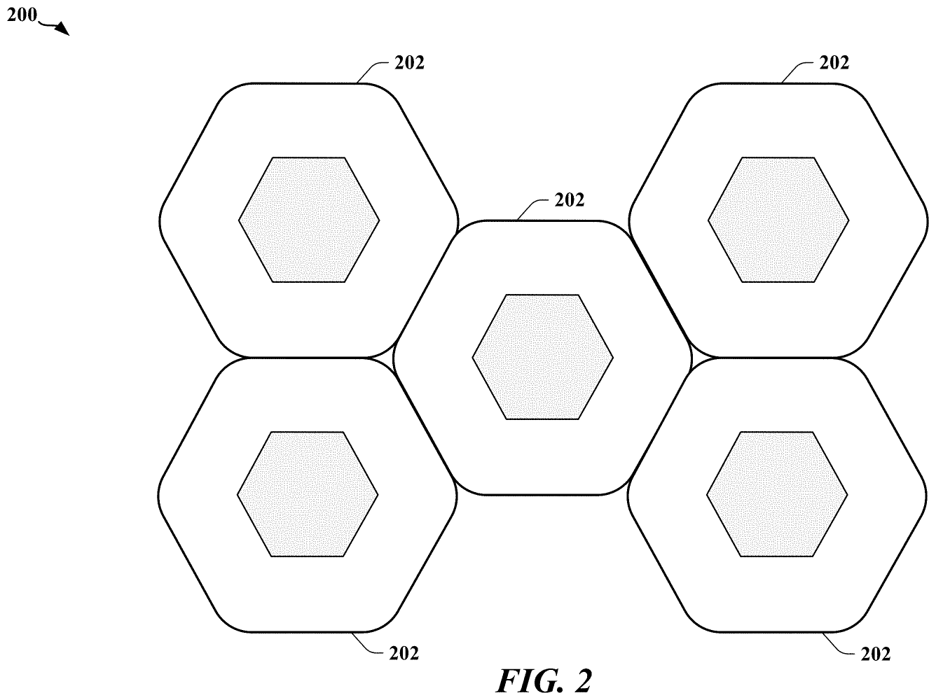

FIG. 2 illustrates an example of an arrangement 200 of charging cells 202 provided on a single layer of a segment or portion of a charging surface that may be adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved to some extent.

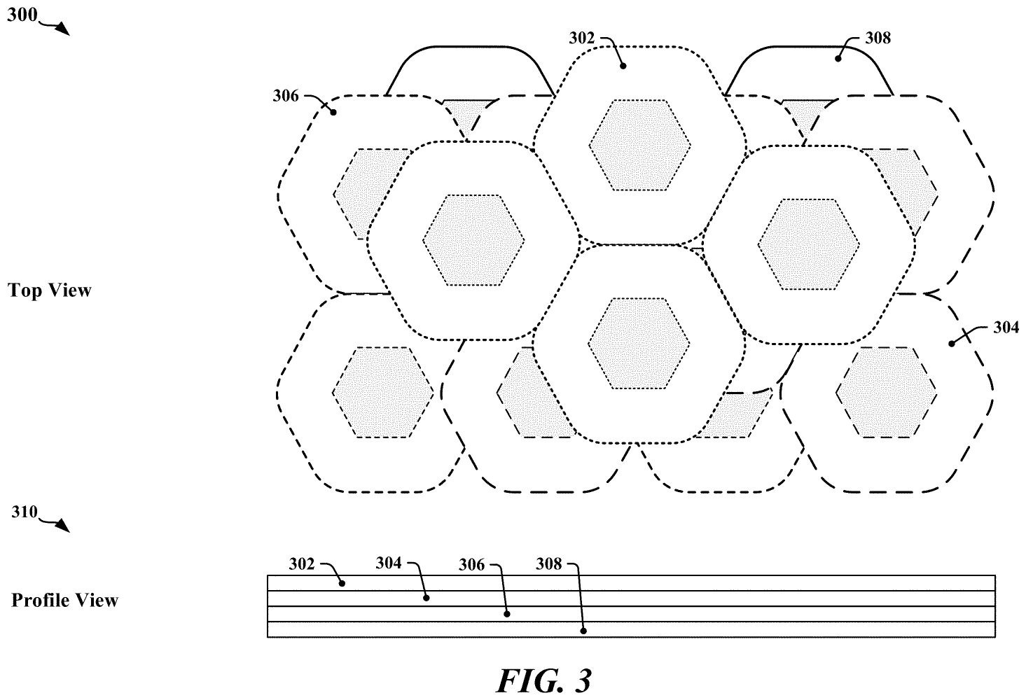

FIG. 3 illustrates an example of an arrangement of charging cells from two perspectives 300, 310 when multiple layers are overlaid within a segment or portion of a charging surface that may be adapted in accordance with certain aspects disclosed herein. Layers of charging cells 302, 304, 306, 308 are provided within the charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more layers. The arrangement of charging cells 100 can be selected to provide complete coverage of a designated charging area that is adjacent to the illustrated segment.

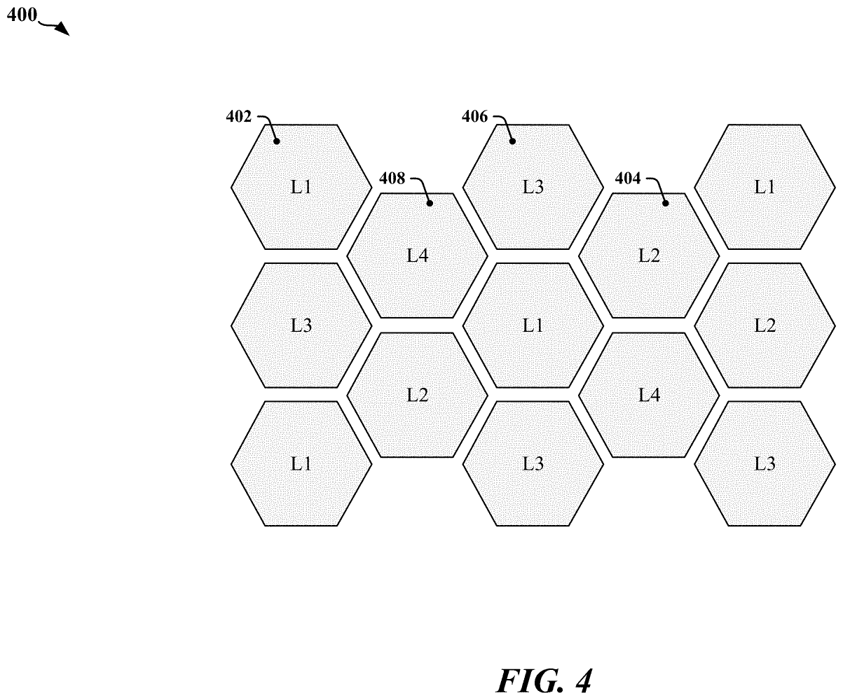

FIG. 4 illustrates the arrangement of power transfer areas provided in a charging surface 400 that employs multiple layers of charging cells configured in accordance with certain aspects disclosed herein. The illustrated charging surface is constructed from four layers of charging cells 402, 404, 406, 408. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

### Wireless Transmitter

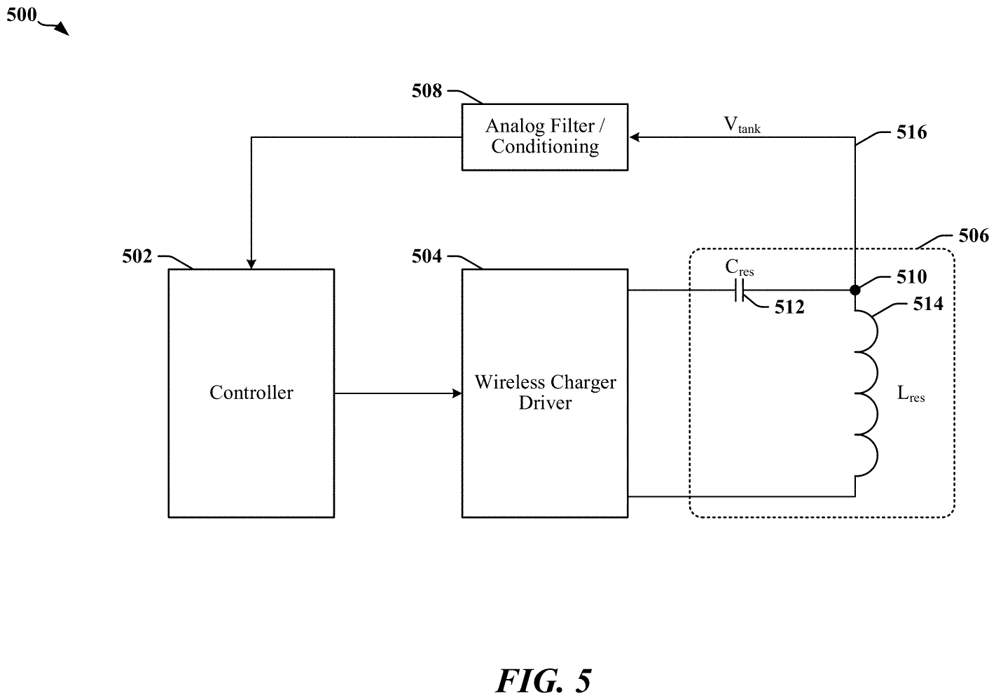

FIG. 5 illustrates an example of a wireless transmitter 500 that can be provided in a base station of a wireless charging device. A base station in a wireless charging device may include one or more processing circuits used to control operations of the wireless charging device. A controller 502 may receive a feedback signal filtered or otherwise processed by a filter circuit 508. The controller may control the operation of a driver circuit 504 that provides an alternating current to a resonant circuit 506. In some examples, the controller 502 may generate a digital frequency reference signal used to control the frequency of the alternating current output by the driver circuit 504. In some instances, the digital frequency reference signal may be generated using a programmable counter or the like. In some examples, the driver circuit 504 includes a power inverter circuit and one or more power amplifiers that cooperate to generate the alternating current from a direct current source or input. In some examples, the digital frequency reference signal may be generated by the driver circuit 504 or by another circuit. The resonant circuit 506 includes a capacitor 512 and inductor 514. The inductor 514 may represent or include one or more transmitting coils in a charging cell that produced a magnetic flux responsive to the alternating current. The resonant circuit 506 may also be referred to herein as a tank circuit, LC tank circuit, or LC tank, and the voltage 516 measured at an LC node 510 of the resonant circuit 506 may be referred to as the tank voltage.

Passive ping techniques may use the voltage and/or current measured or observed at the LC node 510 to identify the presence of a receiving coil in proximity to the charging pad of a device adapted in accordance with certain aspects disclosed herein. Some conventional wireless charging devices include circuits that measure voltage at the LC node 510 of the resonant circuit 506 or the current in the resonant circuit 506. These voltages and currents may be monitored for power regulation purposes and/or to support communication between devices. According to certain aspects of this disclosure, voltage at the LC node 510 in the wireless transmitter 500 illustrated in FIG. 5 may be monitored to support passive ping techniques that can detect presence of a chargeable device or other object based on response of the resonant circuit 506 to a short burst of energy (the ping) transmitted through the resonant circuit 506.

A passive ping discovery technique may be used to provide fast, low-power discovery. A passive ping may be produced by driving a network that includes the resonant circuit 506 with a fast pulse that includes a small amount of energy. The fast pulse excites the resonant circuit 506 and causes the network to oscillate at its natural resonant frequency until the injected energy decays and is dissipated. The response of a resonant circuit 506 to a fast pulse may be determined in part by the resonant frequency of the resonant LC circuit. A response of the resonant circuit 506 to a passive ping that has initial voltage=V₀ may be represented by the voltage V_{LC} observed at the LC node 510, such that:

$${V}_{LC} = {V}_{0} {e}^{- ( \frac{ω}{2 Q} ) t} \qquad ( Eq . 1 )$$

The resonant circuit 506 may be monitored when the controller 502 or another processor is using digital pings to detect presence of objects. A digital ping is produced by driving the resonant circuit 506 for a period of time. The resonant circuit 506 is a tuned network that includes a transmitting coil of the wireless charging device. A receiving device may modulate the voltage or current observed in the resonant circuit 506 by modifying the impedance presented by its power receiving circuit in accordance with signaling state of a modulating signal. The controller 502 or other processor then waits for a data modulated response that indicates that a receiving device is nearby.

### Selectively Activating Coils

According to certain aspects disclosed herein, coils in one or more charging cells may be selectively activated to provide an optimal electromagnetic field for charging a compatible device. In some instances, coils may be assigned to charging cells, and some charging cells may overlap other charging cells. The optimal charging configuration may be selected at the charging cell level. In some examples, a charging configuration may include charging cells in a charging surface that are determined to be aligned with or located close to the device to be charged. A controller may activate a single coil or a combination of coils based on the charging configuration which in turn is based on detection of location of the device to be charged. In some implementations, a wireless charging device may have a driver circuit that can selectively activate one or more transmitting coils or one or more predefined charging cells during a charging event.

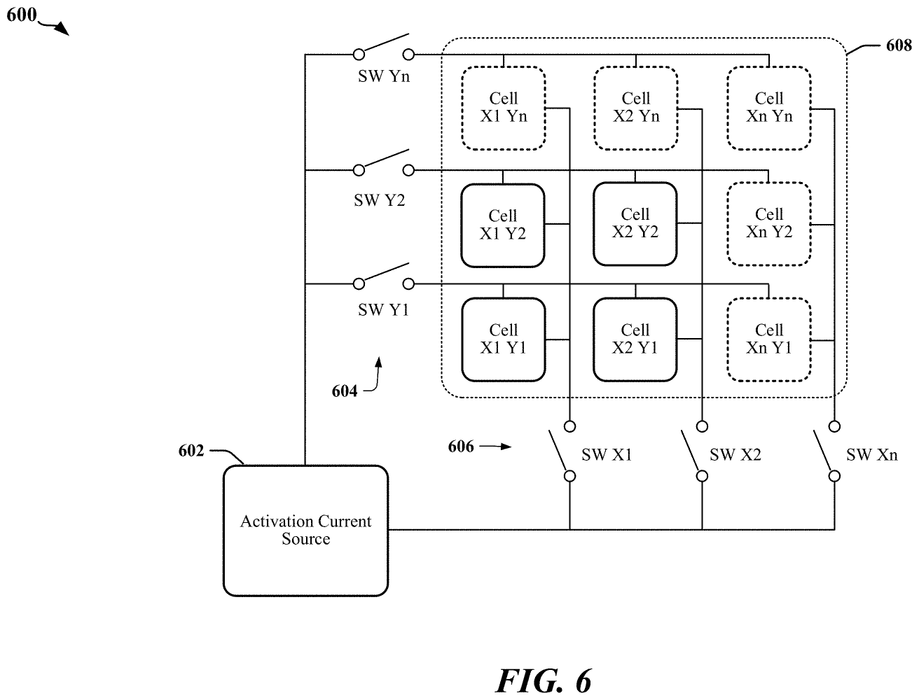

FIG. 6 illustrates a first topology 600 that supports matrix multiplexed switching for use in a wireless charging device adapted in accordance with certain aspects disclosed herein. The wireless charging device may select one or more charging cells 100 to charge a receiving device. Charging cells 100 that are not in use can be disconnected from current flow. A relatively large number of charging cells 100 may be used in the honeycomb packaging configuration illustrated in FIGS. 2 and 3, requiring a corresponding number of switches. According to certain aspects disclosed herein, the charging cells 100 may be logically arranged in a matrix 608 having multiple cells connected to two or more switches that enable specific cells to be powered. In the illustrated topology 600, a two-dimensional matrix 608 is provided, where the dimensions may be represented by X and Y coordinates. Each of a first set of switches 606 is configured to selectively couple a first terminal of each cell in a column of cells to a first terminal of a voltage or current source 602 that provides current to activate coils in one or more charging cells during wireless charging. Each of a second set of switches 604 is configured to selectively couple a second terminal of each cell in a row of cells to a second terminal of the voltage or current source 602. A charging cell is active when both terminals of the cell are coupled to the voltage or current source 602.

The use of a matrix 608 can significantly reduce the number of switching components needed to operate a network of tuned LC circuits. For example, N individually connected cells require at least N switches, whereas a two-dimensional matrix 608 having N cells can be operated with √N switches. The use of a matrix 608 can produce significant cost savings and reduce circuit and/or layout complexity. In one example, a 9-cell implementation can be implemented in a 3×3 matrix 608 using 6 switches, saving 3 switches. In another example, a 16-cell implementation can be implemented in a 4×4 matrix 608 using 8 switches, saving 8 switches.

During operation, at least 2 switches are closed to actively couple one coil or charging cell to the voltage or current source 602. Multiple switches can be closed at once in order to facilitate connection of multiple coils or charging cells to the voltage or current source 602. Multiple switches may be closed, for example, to enable modes of operation that drive multiple transmitting coils when transferring power to a receiving device.

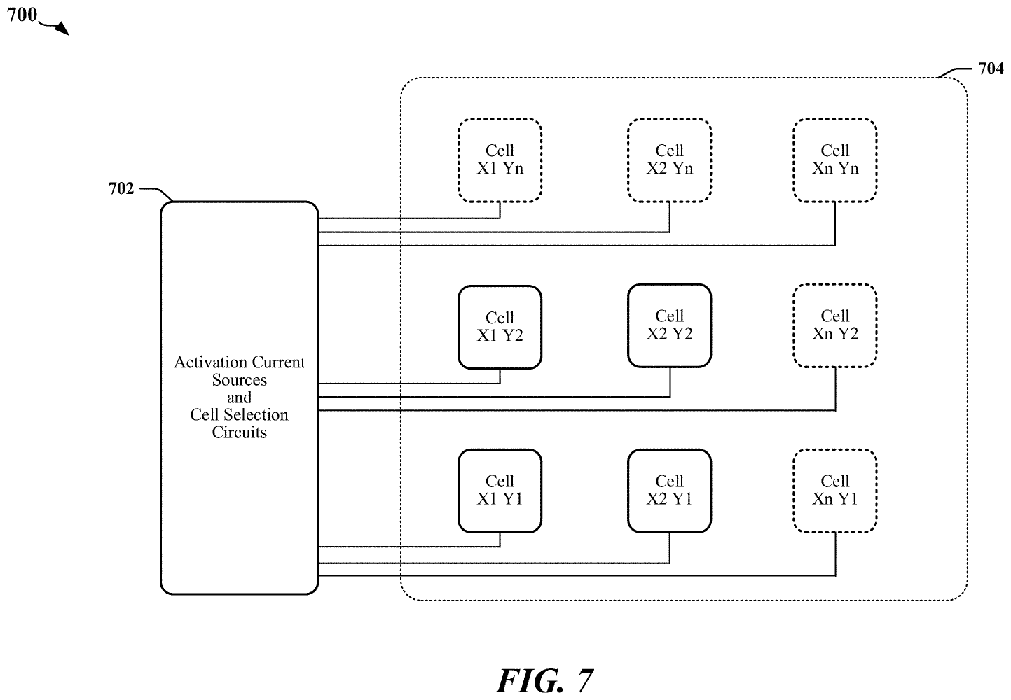

FIG. 7 illustrates a second topology 700 in which each individual coil or charging cell is directly driven by a driver circuit 702 in accordance with certain aspects disclosed herein. The driver circuit 702 may be configured to select one or more coils or charging cells 100 from a group of coils 704 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix may be used to activate the charging cell and/or group of selected coils.

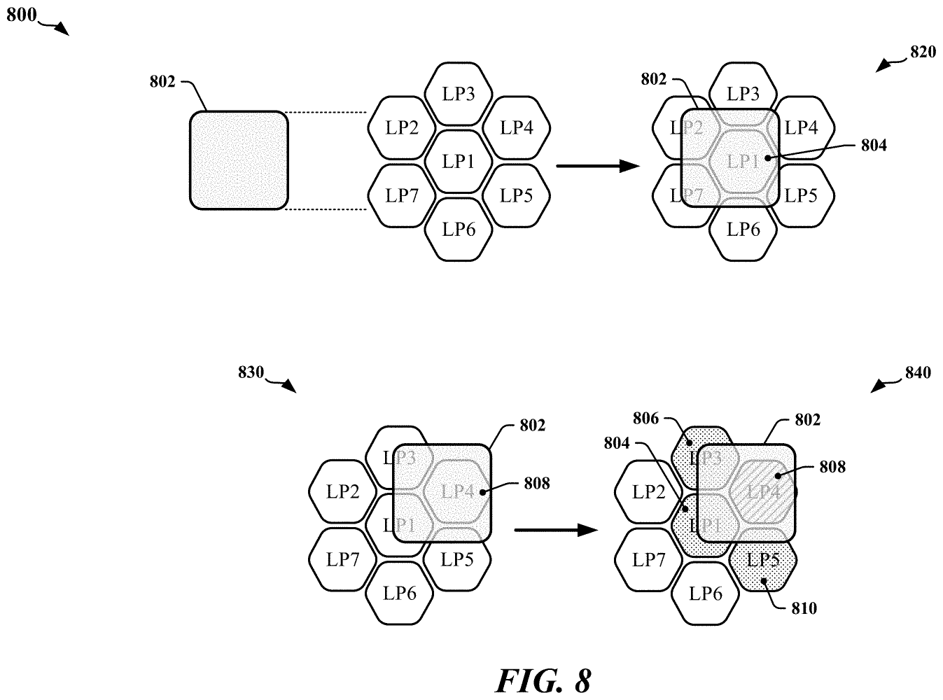

FIG. 8 illustrates certain configurations 800, 820, 830, 840 of a charging surface in a wireless charging device upon which a chargeable device 802 can be freely positioned. The chargeable device 802 has an area that is comparable to the area occupied by each charging cell of a charging surface, or to the area of constituent inductive charging coils in charging cells. In the illustrated example, the chargeable device 802 is somewhat larger than a single charging coil 804. Based on the geometry and arrangement of the charging coils 804, 806, 808, 810 the chargeable device 802 can physically cover adjacent charging coils. In the third and fourth configurations 830, 840, for example, the chargeable device 802 has been placed such that it substantially overlaps a single charging coil 808 and partially covers multiple other charging coils 804, 806, 810. The chargeable device 802 may receive power from one or more charging coils 804, 806, 808, 810 after it has established its presence.

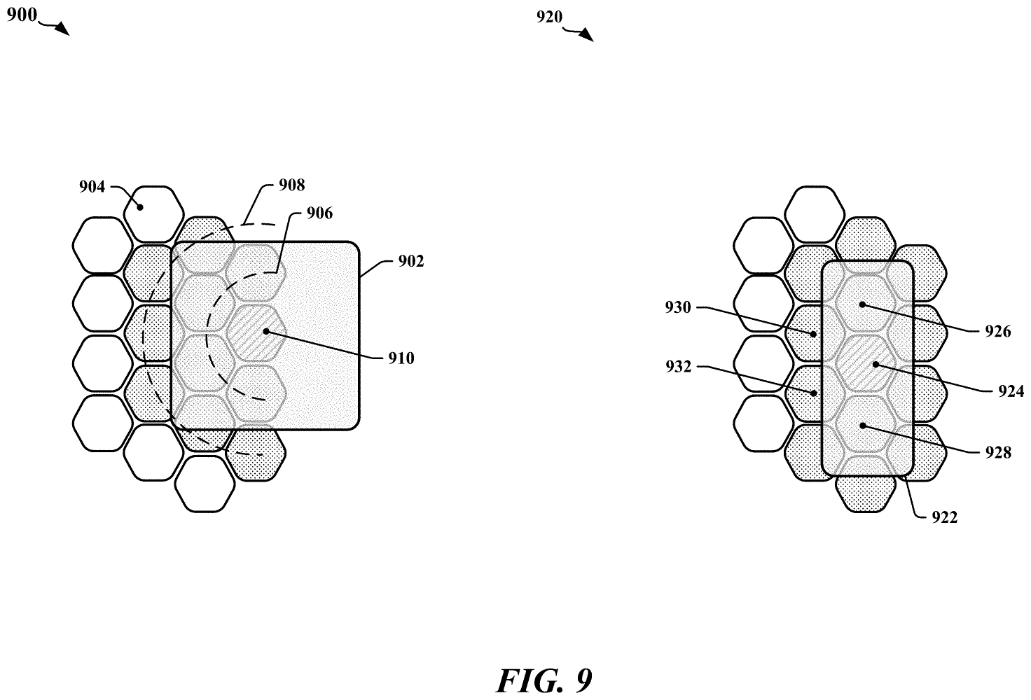

Certain aspects of this disclosure can accommodate charging configurations using multiple adjacent charging coils 804, 806, 808, 810. In accordance with certain aspects of this disclosure, any number of charging coils may be available for charging a chargeable device. FIG. 9 illustrates certain aspects of charging configurations 900, 920 that may be defined for a charging surface when a chargeable device 902, 922 is presented for charging or is being charged. The number and location of usable charging coils may vary based on the type of an optimally-positioned charging coil 910, 926, the charging contract negotiated between the charging surface and the chargeable device 902, 922, and the topology or configuration of the charging surface. For example, the number and location of usable charging coils may be based on the maximum or contracted charging power transmitted through the active coil 910 or potentially through another charging coil 904, or on other factors.

In the first configuration 900, the chargeable device 902 may identify coils that are candidates for inclusion in a charging configuration. In the illustrated example, the chargeable device 902 has been placed such that its center is substantially coaxial with a first charging coil 910. For the purposes of this description, it will be assumed that the center of a first receiving coil 910 within the chargeable device 902 is located at the center of the chargeable device 902. In this example, the wireless charging device may determine that the first charging coil 910 has the strongest coupling with the receiving coil in the chargeable device 902 with respect to the coils in the next bands 906, 908 of charging coils. In one example, the wireless charging device may define the charging configuration as including at least the first charging coil 910. In this example, the charging configuration may identify one or more charging coils in the first band 906 to be activated during charging procedures.

In the second charging configuration 920, the charging surface may employ sensing techniques that can detect the edges of the chargeable device 922. For example, the outline of the chargeable device 922 can be detected using capacitive sense, inductive sense, pressure, Q-factor measurement or any other suitable device locating technology. In some instances, the outline of the chargeable device 922 can be determined using one or more sensors provided in or on the charging surface. In the illustrated example, the chargeable device 922 has an elongated shape. For the purposes of this description, it will be assumed that the center of a first receiving coil 924 within the chargeable device 922 is located at the center of the chargeable device 922. The wireless charging device may determine that the first charging coil 924 has the strongest coupling with the receiving coil in the chargeable device 922. In one example, the wireless charging device may define the charging configuration as including at least the first charging coil 924. Charging coils 926, 928 that are adjacent to the first receiving coil 924 and that lie under and within the outline of the chargeable device 922 may be included in some charging configurations. Other coils 930, 932 that are adjacent to the first receiving coil 924 and that lie partially under and within the outline of the chargeable device 922 may be defined by some charging configurations to be activated during certain charging procedures.

In some examples, a chargeable device may receive power from two or more active coils. In one example, the chargeable device may have a relatively large footprint with respect to the charging surface and may have multiple receiving coils that can engage multiple charging coils to receive power. In another example, a receiving coil of the chargeable device may be placed substantially equidistant from two or more charging coils and a charging configuration may be defined whereby two or more adjacent charging coils in the charging surface provide power to the chargeable device.

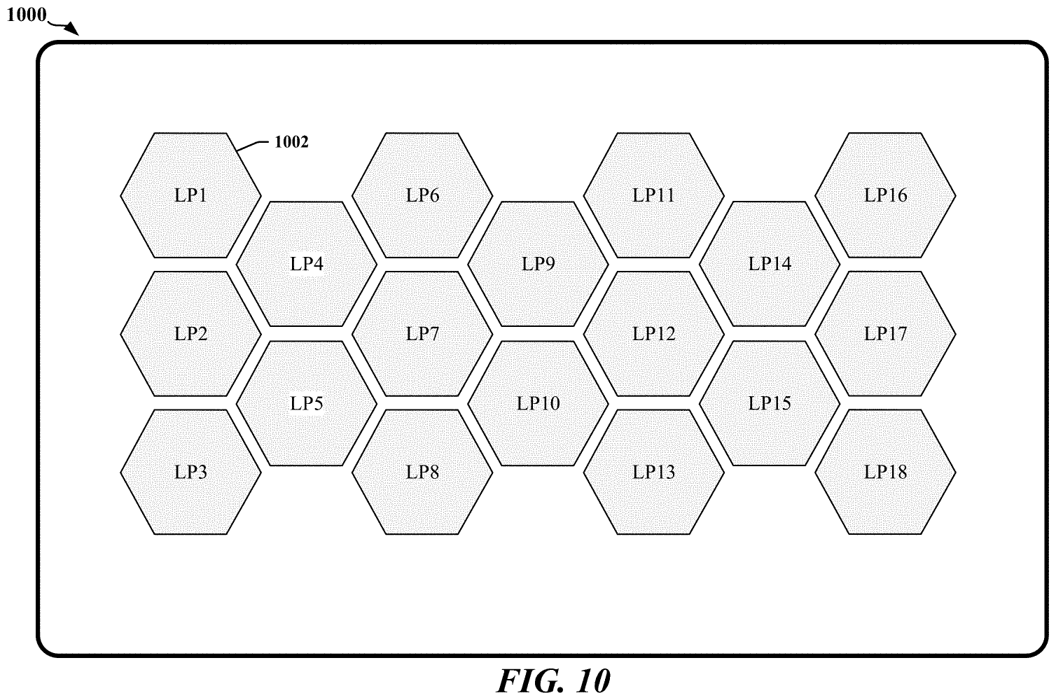

FIG. 10 illustrates an example of a charging surface 1000 implemented in a wireless charging system. The charging surface 1000 may be configured to charge multiple devices that can be freely positioned on any available area of the charging surface 1000. In the illustrated example, the charging surface 1000 may be configured to charge up to three mobile telephones, or the like. The charging surface 1000 may also be designed to charge multiple devices smaller than a mobile telephone and/or one or more larger devices, such as oversized smartphones, tablet computers, notebook computers, or the like. A device to be charged can engage and electromagnetically couple with one or more transmitting coils (marked LP-1 through LP-18) in the charging surface 1000. Certain aspects disclosed herein enable a free-position wireless charger to take advantage of the availability of the charging surface 1000 to charge smaller devices such as a smart watch, smart eyewear, headsets, earbuds, other wearable devices and other types of devices.

According to certain aspects of this disclosure, a charging stand may be provided to mount, support and/or maintain a small-sized device in place on a charging surface. The charging stand may accommodate certain physical features of the small-sized device that may otherwise impede electromagnetic coupling and/or wireless charging. The charging stand may conduct a charging current induced by transmitting coils of the charging surface 1000 to a transmitting coil of the charging stand that is coupled to a receiving coil in the small-sized device mounted on the charging stand.

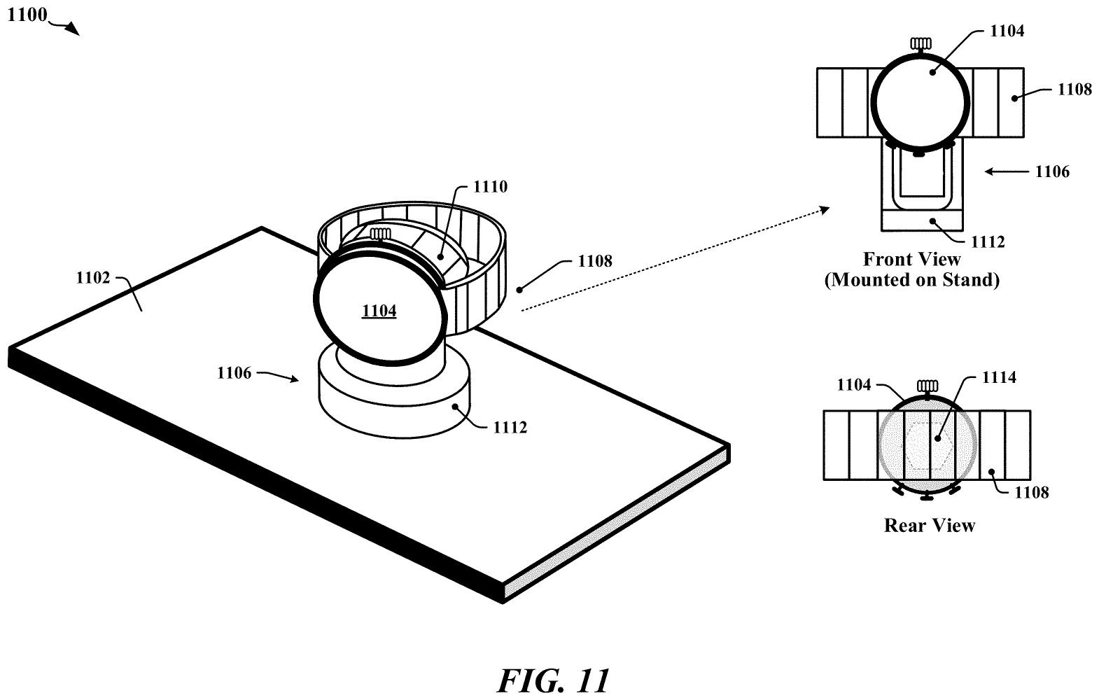

FIG. 11 illustrates an example of a wireless charging system 1100 in which a charging stand 1106 can be used for wirelessly charging a watch 1104 when the charging stand is mounted on a charging surface of a wireless charging device 1102. In some instances, the charging stand 1106 may engage a watch 1104 that has a closed band 1108, where the closed band 1108 may prevent a receiving coil 1114 on the back of the watch 1104 from achieving adequate electromagnetic coupling in a conventional charging configuration where the watch 1104 would be placed directly on the charging surface of the wireless charging device 1102. Inadequate electromagnetic coupling can lead to a failure to charge, or can result in a slow charging process.

In the illustrated example, the charging stand 1106 has a vertically-oriented housing portion or stand 1110 that includes a transmitting coil positioned adjacent to the back of the watch 1104 when the watch 1104 is mounted on the charging stand 1106. The transmitting coil may be configured to couple or engage with the receiving coil 1114 in the back of the watch 1104, such that the watch 1104 can efficiently receive electromagnetic flux from the charging stand 1106. A second, horizontal housing portion or base 1112 has a receiving coil configured to engage one or more transmitting coils of the wireless charging device 1102, when the charging stand 1106 is placed on the surface of the wireless charging device 1102. A power transfer circuit provided within the charging stand 1106 receives an induced current from the receiving coil in the base 1112 of the charging stand 1106 and is configured to provide a charging current to the transmitting coil in the stand 1110 of the charging stand 1106.

The physical design of the charging stand 1106 may vary based on application needs, chargeable device size and configuration. The physical design of the charging stand 1106 may be configured to accommodate or enable certain interactions with the chargeable device during charging. In one example, at least a portion of the stand 1110 may be hinged or mounted on a swivel such that the watch 1104 can be positioned at an incline to a vertical axis that is generally aligned with the flow of flux through the transmitting coils in the wireless charging device 1102.

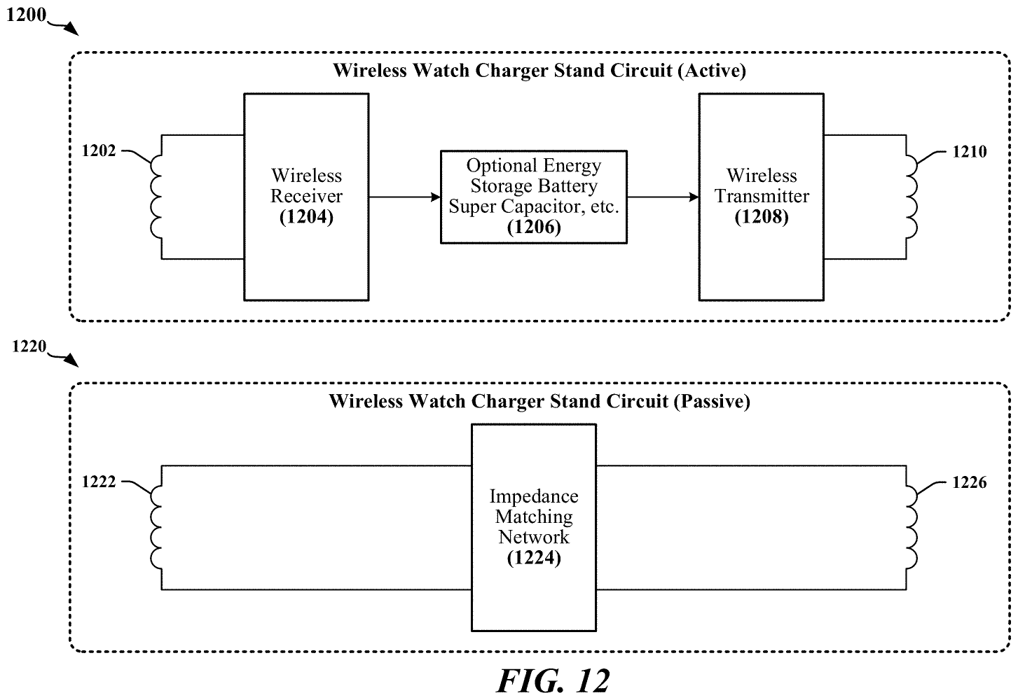

FIG. 12 illustrates examples of power transfer circuits 1200, 1220 than may be housed within the charging stand 1106 in accordance with certain aspects disclosed herein. A first power transfer circuit 1200 can translate between charging protocols and can operate in a standalone manner, in which power need not be received from a wireless charging device while charging a watch or other chargeable device. The first power transfer circuit 1200 includes an energy storage element 1206 that may be implemented using a battery, super capacitor and/or another energy storage device. The energy storage element 1206 receives a charging current from a receiving circuit 1204. In some implementations, the receiving circuit 1204 manages charging events and/or converts an alternating current (AC) current induced in a receiving coil 1202 that is energized by electromagnetic flux transmitted through the charging surface of the wireless charging device 1102 to a direct current (DC). The receiving circuit 1204 may initiate and control certain charging events. The energy storage element 1206 supplies a charging current to a wireless transmitting circuit 1208 that drives the transmitting coil 1210 used to charge the watch 1104. In some examples, the first power transfer circuit 1200 includes an inverter configured to convert the charging current from DC to AC. In one example, the inverter is included in the wireless transmitting circuit 1208.

In some examples, the wireless receiving circuit 1204 and the wireless transmitting circuit 1208 may be independently configured to support one or more wireless charging protocols. The wireless receiving circuit 1204 and the wireless transmitting circuit 1208 may operate in accordance with the same or different wireless charging protocols. In some examples, the charging stand 1106 can act as an adapter to permit charging of a device in accordance with a first wireless charging standard or protocol using energy received from a wireless charging device in accordance with a second wireless charging standard or protocol.

In some examples, the wireless receiving circuit 1204 and the wireless transmitting circuit 1208 may operate independently. In these examples, the charging stand 1106 can charge the watch 1104 autonomously when the charging stand 1106 is not actively receiving energy through the charging surface of the wireless charging device 1102.

The second power transfer circuit 1220 includes an impedance matching circuit 1224 that enables AC current received from the wireless receiving coil 1222 to be used to drive a wireless transmitting coil 1226. The second circuit 1220 can operate in a passive, or pass-through mode.

Certain battery-powered devices may be configured to be wirelessly recharged using one of a number of wireless charging protocols. Wireless charging protocols may include standards-defined protocols defined by industry-specific organizations, consortiums and proprietary protocols implemented by individual manufacturers or groups of manufacturers. In some examples, wireless charging systems provided in accordance with certain aspects disclosed herein may be configured to select between different wireless charging protocols to charge certain devices. In one aspect of the disclosure, a wireless charging stand may be operated as an adaptation circuit or interface between a wireless charging device operated in accordance with a first wireless charging protocol to charge a device that is chargeable wireless in accordance with a second wireless charging protocol.

In one example, the charging stand 1106 illustrated in FIG. 11 may be adapted to charge a watch 1104 using a first proprietary protocol in either a standalone mode or when placed on a charging surface of the wireless charging device 1102. The charging stand 1106, when placed on the charging surface of the wireless charging device 1102, may receive power from the wireless charging device 1102 in accordance with a standards-based protocol, the first proprietary protocol, or a second proprietary protocol that is used by the wireless charging device 1102 to charge devices placed directly on a surface of the wireless charging device 1102.

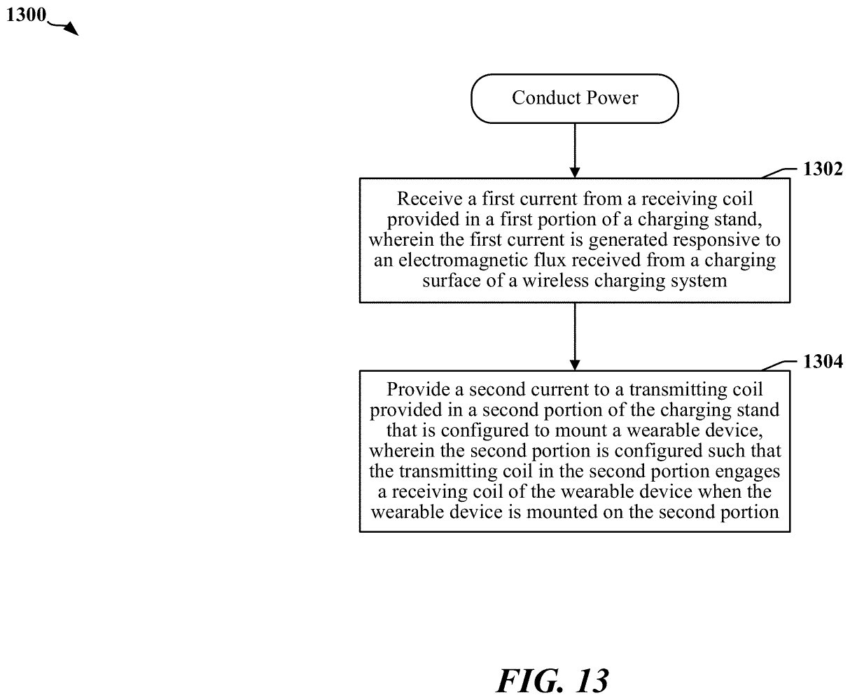

FIG. 13 is flowchart 1300 illustrating one example of a method for conducting power from a charging surface. The method may be performed by a power transfer circuit provided in a charging stand. At block 1302, the power transfer circuit may receive a first current from a receiving coil provided in a first portion of a charging stand. The first current may be generated responsive to an electromagnetic flux received from a charging surface of a wireless charging system. At block 1304, the power transfer circuit may provide a second current to a transmitting coil provided in a support of the charging stand that is configured to mount a wearable device. The support may be configured such that the transmitting coil in the support engages a receiving coil of the wearable device when the wearable device is mounted on the support.

In certain examples, the power transfer circuit may provide the first current to an impedance matching network that couples the receiving coil in the first portion to the transmitting coil in the support. In one example, the wearable device includes a watch, and the support is configured to provide a surface parallel to a back surface of the watch when the wearable device is mounted on the support.

In certain examples, the power transfer circuit may provide the first current to an energy storage element. The second current may be drawn from the energy storage element. The power transfer circuit may configure a wireless receiver circuit coupled to the receiving coil in the first portion to be operated in accordance with a first wireless charging protocol. The power transfer circuit may configure a wireless transmitter circuit coupled to the transmitting coil in the support to be operated in accordance with a second wireless charging protocol. In some instances, the first wireless charging protocol and the second wireless charging protocol are the same. In some instances, the first wireless charging protocol and the second wireless charging protocol are compatible with one another. In some instances, the first wireless charging protocol is different from the second wireless charging protocol. The current provided to the transmitting coil in the support may continue to flow when the current is received from the receiving coil is terminated.

Charging devices operated in accordance with certain proprietary wireless charging protocols can draw and dissipate a significant amount of power when the charging devices are in a standby mode. A wireless charging device may be in standby mode when it is not actively transmitting power to a chargeable device. For example, when a device may not have been placed on the charging stand or wireless charging device, or otherwise presented for charging. The power consumption in standby mode typically necessitates that a charging stand 1106 has a continuous independent power source when configured for the proprietary wireless charging protocols.

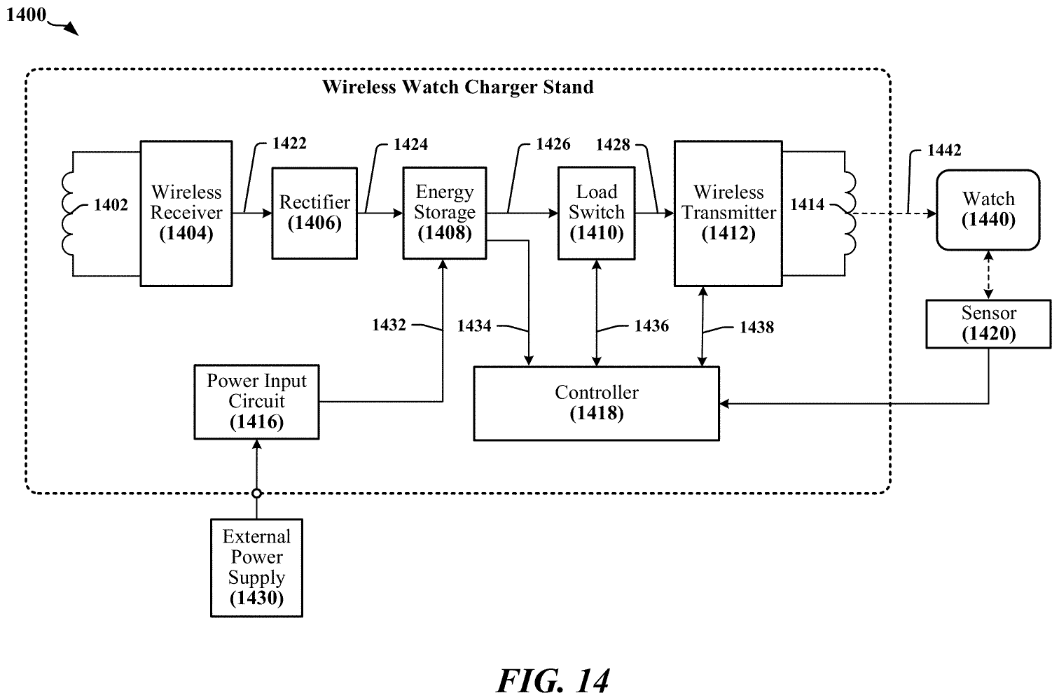

FIG. 14 illustrates an example of a power transfer circuit 1400 that may be housed within the charging stand 1106 in accordance with certain aspects disclosed herein. The power transfer circuit 1400 includes a receiving circuit 1404 and an energy storage circuit 1408. The receiving circuit 1404 is coupled to a receiving coil 1402 configured to produce an induced current 1422 when energized by electromagnetic flux transmitted through a charging surface of an external wireless charging device. The energy storage circuit 1408 may include a battery, super capacitor or other storage device. The power transfer circuit 1400 may include a rectifier 1406 configured to convert the induced current 1422 from AC to DC and to produce a rectified induced current 1424. The rectifier 1406 may include or cooperate with a regulator, voltage booster circuit, overvoltage protection circuit, overcurrent protection circuit, filter and/or other power conditioning circuits to provide the rectified induced current 1424. The rectified induced current 1424 is provided to the energy storage circuit 1408 and may be used to charge the battery, super capacitor or other storage device. In some examples, the rectifier 1406, regulator, voltage booster circuit, overvoltage protection circuit, overcurrent protection circuit, filter and/or other power conditioning circuits may be included in the energy storage circuit 1408.

A transmitting circuit 1412 may be configured to transmit power by generating a magnetic flux 1442 in a transmitting coil 1414. In the illustrated example, the magnetic flux 1442 is directed to a watch 1440 or other chargeable device mounted on the charging stand 1106. The energy storage circuit 1408 provides a driver current 1426 to a load switch 1410 for transmission to a transmitting circuit 1412 during charging operations. In some examples, the energy storage circuit 1408 provides the driver current 1426 from the rectified induced current 1424 when the receiving circuit 1404 is receiving power from the receiving coil 1402. The energy storage circuit 1408 may provide the driver current 1426 from the battery, super capacitor or other storage device when the receiving circuit 1404 is not receiving power from the receiving coil 1402. The load switch 1410 responds to one or more control signals 1436 provided by a controller 1418. The controller 1418 may be capable of low-power operation, and may be operable in a hibernate or sleep mode.

The controller 1418 may cause the load switch 1410 to use the driver current 1426 to provide an input current 1428 to the transmitting circuit 1412. In some examples, the transmitting circuit 1412 provides the input current 1428 directly to the transmitting coil 1414 to generate the magnetic flux 1442 when charging the watch 1440. In these examples, the controller 1418 may control the level of the input current 1428 through the control signals 1436 provided to the load switch 1410. In some examples, the transmitting circuit 1412 controls the level of current provided to the transmitting coil 1414 when charging the watch 1440 based on control signals 1438 received from the controller 1418.

The receiving circuit 1404 may be configured to manage charging events between the power transfer circuit 1400 and an external wireless charging device. The energy storage circuit 1408 may be configured to receive the induced current 1422 from the receiving circuit 1404 or the rectified induced current 1424 from the receiving circuit 1404 when the charging stand 1106 is placed on a compatible charging device that is actively transferring power to the receiving coil 1402 and the receiving circuit 1404 of the charging stand 1106. The energy storage circuit 1408 may also be configured to receive an input current 1432 from a power input circuit 1416 that receives power from an external power supply 1430. The power input circuit 1416 may include power conditioning circuits that may include a rectifier circuit, voltage regulator, voltage booster circuit, overvoltage protection circuit, overcurrent protection circuit, filter or the like. The induced current 1422, the rectified induced current 1424 or the input current 1432 may be used to replenish the energy storage circuit 1408 and may be further used to provide power 1434 to the controller 1418 and other circuits of the power transfer circuit 1400.

In many instances, none of the induced current 1422, rectified induced current 1424 and input current 1432 are available. In these instances, power may be provided by the energy storage circuit 1408 to supply power 1434 to the controller 1418 and/or to provide the driver current 1426 to the load switch 1410. The power transfer circuit 1400 may enter a standby mode when the watch 1440 is not mounted on the charging stand 1110 or has terminated wireless charging. The energy storage circuit 1408 may be gradually drained when supporting operation during standby mode due to power draws by the controller 1418 and other circuits of the power transfer circuit 1400. The drain on the energy storage circuit 1408 during standby mode may prevent complete charging of the watch 1440 during a next charging procedure and may, in time, render the power transfer circuit 1400 inoperative.

In accordance with certain aspects of this disclosure, the controller 1418 may implement a power-saving mode within a standby mode by powering down certain portions of the power transfer circuit 1400. The controller 1418 may be coupled to one or more low-power sensors 1420 that are configured to detect the presence of the chargeable device. The controller 1418 may terminate the power-saving mode and fully power up the power transfer circuit 1400 when a device is detected. The controller 1418 may commence a charging procedure after detecting that a device has been placed on the charging stand 1106. The controller 1418 may power down portions of the power transfer circuit 1400 and/or re-enter the power-saving mode when a controller 1418 detects or indicates removal of the device.

In some examples, the controller 1418 may periodically exit power-saving mode when no sensor is available to detect presence of a chargeable device. The controller 1418 may use the transmitting circuit 1412 to determine when a chargeable device is mounted on the charging stand 1110. In some examples, the controller 1418 may search for chargeable devices, and identify the type and capabilities of any chargeable device present on the charging stand 1110. In some instances, the chargeable device may be fully charged or an incompatible device may be mounted on the charging stand 1110, and the controller 1418 may cause the power transfer circuit 1400 to reenter power-saving mode. The controller 1418 may configure a long periodicity for wake up in order to determine if a device mounted on the charging stand 1110 requires charging after previously determining that the chargeable device is fully charged. The period between wakeups in the latter case may be measured in minutes or tens of minutes in order to preserve power. Sensor detection of removal may cause immediate termination of the power-saving mode and may cause the controller 1418 to terminate long periodicity wake up. When no sensor is present, the controller 1418 may use the transmitting circuit 1412 to detect presence of a chargeable device and may set different periodicities for wakeup. In one example, the controller 1418 may wake up the power transfer circuit 1400 to perform device detection procedures multiple times a second when no device is present and may set a periodicity measured in multiple seconds to wake up the power transfer circuit 1400 for device detection procedures when a device is present and charging is not required or has been completed.

In some examples, the controller 1418 may power down portions of the power transfer circuit 1400 by causing the load switch 1410 to terminate current 1428 flowing to the transmitting circuit 1412. In some examples, the controller 1418 may enter a power-saving mode in which it hibernates or sleeps. In the latter examples, the controller 1418 may exit the power-saving mode upon receipt of an interrupt or another signal that indicates detection of the presence or removal of the chargeable device by a controller 1418. The controller 1418 may exit the power-saving mode in response to an interrupt or other signal generated by a timer or real time clock, whereby the controller exits the power-saving mode to poll or read the sensor 1420 or perform a device detection procedure. In one example, the controller 1418 may reenter the power-saving mode or may power up the power transfer circuit 1400 based on information obtained from the sensor 1420.

Sensors 1420 may provide measurements or detections indicating presence, position and/or orientation of the chargeable device. In some examples, one or more sensors 1420 may be configured or used to detect differences or changes in capacitance, resistance, inductance, touch, pressure, temperature, load, strain, and/or another appropriate type of sensing. In some examples, one or more sensors 1420 may be configured or detect or measure deformation, loading and/or weight attributable to a chargeable device placed on the charging stand 1106. In some examples, one or more sensors 1420 may be configured or detect or measure movement or vibration. In some examples, one or more sensors 1420 may be configured for use as infrared, radar or ultrasonic motion detectors. In some examples, one or more sensors 1420 may include thermally-sensitive devices that can be used to detect changes in temperature associated with placement of a chargeable device on the charging stand 1106 or removal of a chargeable device from the charging stand 1106.

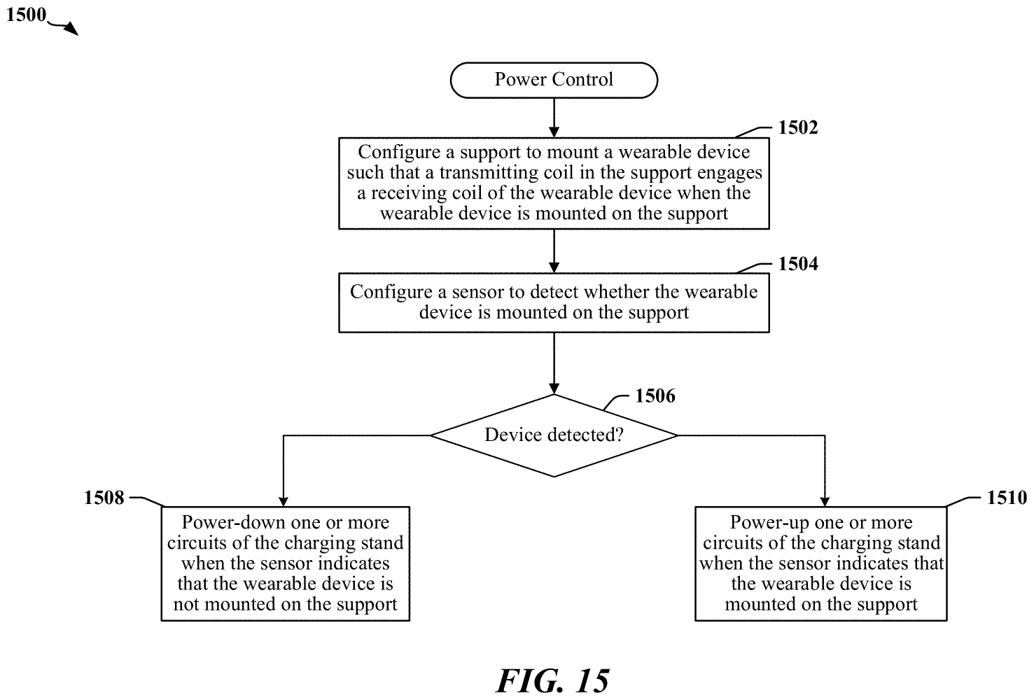

FIG. 15 is flowchart 1500 illustrating an example of a power control method according to certain aspects of this disclosure. The method may relate to the use of a charging stand to hold a watch or other wearable device while the watch or wearable device is being wirelessly charged. At block 1502, a support portion of a charging stand may be configured to mount a wearable device such that a transmitting coil in the support portion engages a receiving coil of the wearable device when the wearable device is mounted on the support portion. At block 1504, a sensor may be configured to detect whether the wearable device is mounted on the support portion. At block 1506, a controller may be configured to determine whether a wearable device is mounted on the support portion. When it is determined that the wearable device is not mounted on the support portion, then at block 1508, the controller may power-down one or more circuits of the charging stand. When it is determined that the wearable device is mounted on the support portion, then at block 1510, the controller may power-up the one or more circuits of the charging stand when the sensor indicates that the wearable device is mounted on the support portion.

In certain examples, a charging circuit is configured to generate a charging current when powered by an energy storage device, and the controller may be configured to cause the charging circuit to provide the charging current to the transmitting coil after powering-up the one or more circuits of the charging stand. A switch may be configured to couple the energy storage device to the charging circuit when the one or more circuits of the charging stand are powered-up. In one example, the energy storage device includes a battery. In another example, the energy storage device includes a capacitive storage device. The energy storage device may be configured to receive a replenishing current when a power supply is coupled to the charging stand. The energy storage device may be configured to receive a replenishing current from a wireless receiver circuit when the charging stand is placed on a wireless charging device. The wireless receiver circuit may be coupled to a receiving coil located in a base of the charging stand. The charging circuit may be operated in accordance with a first wireless charging protocol and the wireless receiver circuit may be operated in accordance with a second wireless charging protocol are the same or are compatible with one another. In some instances, the first wireless charging protocol may be different from the second wireless charging protocol. In some instances, the first wireless charging protocol and the second wireless charging protocol are the same or are compatible with one another.

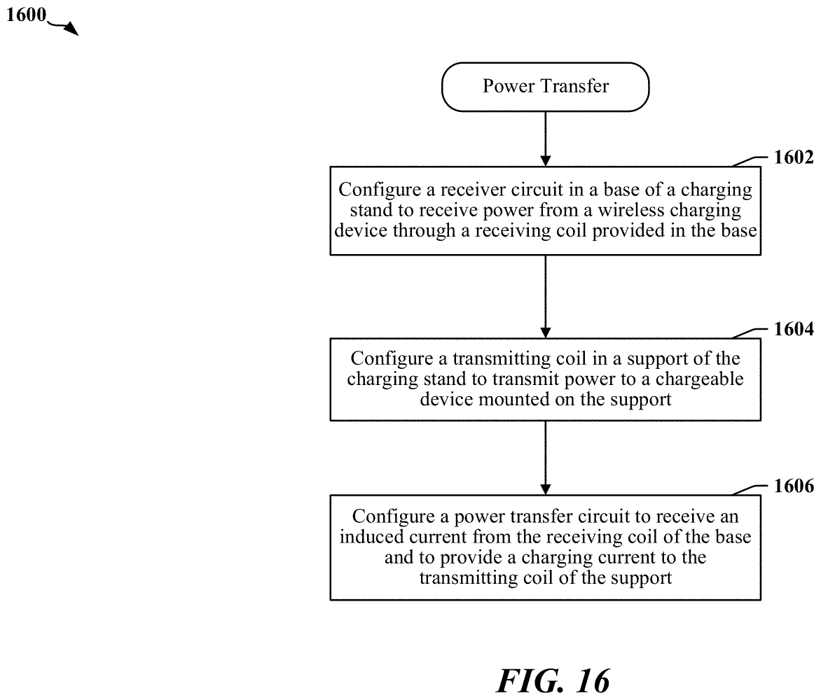

FIG. 16 is flowchart 1600 illustrating an example of a power transfer method according to certain aspects of this disclosure. The method may relate to the use of a charging stand to hold a watch or other chargeable device while the watch or chargeable device is being wirelessly charged. At block 1602, a receiver circuit in a base of a charging stand is configured to receive power from a wireless charging device through a receiving coil provided in the base. At block 1604, a transmitting coil in a support of the charging stand is configured to transmit power to a chargeable device mounted on the support. At block 1606, a power transfer circuit is configured to receive an induced current from the receiving coil of the base and to provide a charging current to the transmitting coil of the support. In one example, the power transfer circuit includes an impedance matching network that couples the receiving coil to the transmitting coil in the support.

In some examples, an energy storage device is configured to receive the induced current or a rectified current derived from the induced current and a transmitter circuit is configured to use the rectified current or a current output by the energy storage device to provide the charging current to the transmitting coil. The energy storage device may include a battery or a capacitive storage device. The receiver circuit may be operated in accordance with a first wireless charging protocol and the transmitter circuit may be operated in accordance with a second wireless charging protocol are the same or are compatible with one another. In one example, the first wireless charging protocol and the second wireless charging protocol may be the same or may be compatible with one another. The first wireless charging protocol may be different from the second wireless charging protocol.

In some examples, a sensor is configured to detect whether the chargeable device is mounted on the support and one or more circuits of the power transfer circuit may be powered-down when the sensor indicates that the chargeable device is not mounted on the support and powered-up when the sensor indicates that the chargeable device is mounted on the support. A switch may be configured to couple the energy storage device to a transmitter circuit when the circuits of the charging stand are powered-up. The transmitter circuit may be configured to provide the charging current to the transmitting coil.

In some examples, the support is configured to align the transmitting coil parallel to a back surface of a watch when the watch is mounted on the support.

### Example of a Processing Circuit

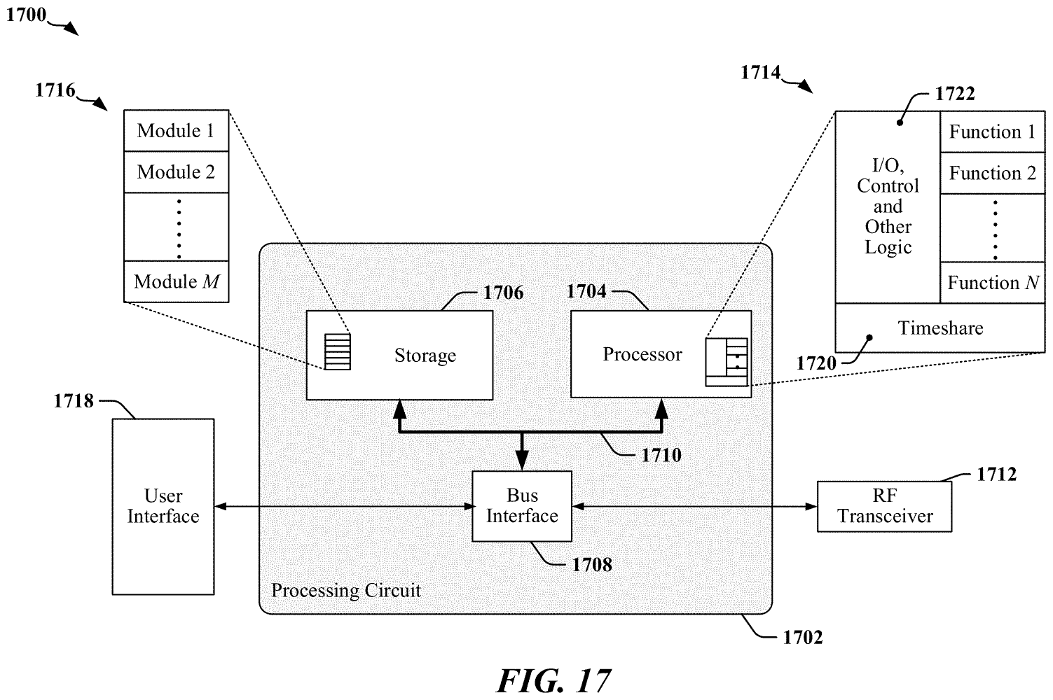

FIG. 17 illustrates an example of a hardware implementation for an apparatus 1700 that may be incorporated in a wireless charging device or in a receiving device that enables a battery to be wirelessly charged. In some examples, the apparatus 1700 may perform one or more functions disclosed herein. In accordance with various aspects of the disclosure, an element, or any portion of an element, or any combination of elements as disclosed herein may be implemented using a processing circuit 1702. The processing circuit 1702 may include one or more processors 1704 that are controlled by some combination of hardware and software modules. Examples of processors 1704 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media. The storage 1706 may include transitory storage media and/or non-transitory storage media.

The bus 1710 may also link various other circuits such as timing sources, timers, peripherals, voltage regulators, and power management circuits. A bus interface 1708 may provide an interface between the bus 1710 and one or more transceivers 1712. In one example, a transceiver 1712 may be provided to enable the apparatus 1700 to communicate with a charging or receiving device in accordance with a standards-defined protocol. Depending upon the nature of the apparatus 1700, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer-readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain and/or organize software in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704 and may manage access to external devices such as a transceiver 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to a transceiver 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the transceiver 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

In certain examples, the apparatus 1700 includes or operates as a power transfer circuit in a charging stand configured to hold a chargeable device. The apparatus 1700 may have a housing that includes a first portion and a support. The first portion is configured to be placed on a charging surface and includes a receiving coil configured to engage a transmitting coil of a charging surface. The support is configured to mount a wearable device and is further configured such that a transmitting coil in the support engages a receiving coil of the wearable device when the wearable device is mounted on the support. The power transfer circuit is configured to provide a current to the transmitting coil in the support, where the current is generated from a current received from the receiving coil in the first portion.

In one example, the power transfer circuit may provide the first current to an energy storage element. The second current may be drawn from the energy storage element. The power transfer circuit may configure a wireless receiver circuit coupled to the receiving coil in the first portion to be operated in accordance with a first wireless charging protocol. The power transfer circuit may configure a wireless transmitter circuit coupled to the transmitting coil in the support to be operated in accordance with a second wireless charging protocol. In some instances, the first wireless charging protocol and the second wireless charging protocol are the same. In some instances, the first wireless charging protocol and the second wireless charging protocol are compatible with one another. In some instances, the first wireless charging protocol is different from the second wireless charging protocol. The current provided to the transmitting coil in the support may continue to flow when the current is received from the receiving coil is terminated.

In certain examples, the power transfer circuit may provide the first current to an impedance matching network that couples the receiving coil in the first portion to the transmitting coil in the support. In one example, the wearable device includes a watch, and the support is configured to provide a surface parallel to a back surface of the watch when the wearable device is mounted on the support.

In certain other examples, the apparatus 1700 includes or operates as a power transfer circuit in a charging stand configured to hold a chargeable device. The apparatus 1700 includes a base that has a receiver circuit configured to receive power from a wireless charging device through a receiving coil provided in the base, a support that that has a transmitting coil configured to transmit power to a chargeable device mounted on the support, and a power transfer circuit configured to receive an induced current from the receiving coil of the base and to provide a charging current to the transmitting coil of the support.

In one example, the power transfer circuit has an impedance matching network that couples the receiving coil to the transmitting coil in the support.

In one example, the apparatus 1700 includes an energy storage device configured to receive the induced current or a rectified current derived from the induced current and a transmitter circuit configured to use the rectified current or a current output by the energy storage device to provide the charging current to the transmitting coil. The energy storage device may include a battery or a capacitive storage device. The receiver circuit may be operated in accordance with a first wireless charging protocol and the transmitter circuit is operated in accordance with a second wireless charging protocol are the same or are compatible with one another. In one example, the first wireless charging protocol and the second wireless charging protocol may be the same or be compatible with one another. In another example, the first wireless charging protocol is different from the second wireless charging protocol.

In some examples, the apparatus 1700 includes a sensor configured to detect whether the chargeable device is mounted on the support and a controller coupled to the sensor. The controller may be configured to power-down one or more circuits of the power transfer circuit when the sensor indicates that the chargeable device is not mounted on the support and power-up the one or more circuits of the power transfer circuit when the sensor indicates that the chargeable device is mounted on the support.

In some examples, the apparatus 1700 includes a switch configured to couple the energy storage device to a transmitter circuit when the one or more circuits of the charging stand are powered-up. The transmitter circuit may be configured to provide the charging current to the transmitting coil. In one example, the chargeable device is a watch and the support is configured to align the transmitting coil parallel to a back surface of the watch when the chargeable device is mounted on the support.

In some examples, the storage 1706 maintains instructions and information where the instructions are configured to cause the one or more processors 1704 to manage the power transfer circuit in accordance with certain aspects disclosed herein. For example, the storage 1706 may include instructions, code and other information configured to cause the one or more processors 1704 to configure a receiver circuit in a base of a charging stand to receive power from a wireless charging device through a receiving coil provided in the base to configure a transmitting coil in a support of the charging stand to transmit power to a chargeable device mounted on the support and to configure a power transfer circuit to receive an induced current from the receiving coil of the base and to provide a charging current to the transmitting coil of the support. In one example, the power transfer circuit includes an impedance matching network that couples the receiving coil to the transmitting coil in the support.

In some examples, the storage 1706 may include instructions, code and other information that cause the one or more processors 1704 to configure an energy storage device to receive the induced current or a rectified current derived from the induced current and to configure a transmitter circuit to use the rectified current or a current output by the energy storage device to provide the charging current to the transmitting coil. The energy storage device may include a battery or a capacitive storage device. The receiver circuit may be operated in accordance with a first wireless charging protocol and the transmitter circuit may be operated in accordance with a second wireless charging protocol are the same or are compatible with one another. In one example, the first wireless charging protocol and the second wireless charging protocol may be the same or may be compatible with one another. The first wireless charging protocol may be different from the second wireless charging protocol.

In some examples, a sensor is configured to detect whether the chargeable device is mounted on the support and one or more circuits of the power transfer circuit may be powered-down when the sensor indicates that the chargeable device is not mounted on the support and powered-up when the sensor indicates that the chargeable device is mounted on the support. A switch may be configured to couple the energy storage device to a transmitter circuit when the circuits of the charging stand are powered-up. The transmitter circuit may be configured to provide the charging current to the transmitting coil.

In some examples, the support is configured to align the transmitting coil parallel to a back surface of a watch when the watch is mounted on the support.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A charging stand, comprising:
a base that has a receiver circuit configured to receive power from a wireless charging device through a receiving coil provided in the base;
a support that that has a transmitting coil configured to transmit power to a chargeable device mounted on the support; and
a power transfer circuit configured to receive an induced current from the receiving coil of the base and to provide a charging current to the transmitting coil of the support.

2. The charging stand of claim 1, wherein the power transfer circuit comprises an impedance matching network that couples the receiving coil to the transmitting coil in the support.

3. The charging stand of claim 1, further comprising:
an energy storage device configured to receive the induced current or a rectified current derived from the induced current; and
a transmitter circuit configured to use the rectified current or a current output by the energy storage device to provide the charging current to the transmitting coil.

4. The charging stand of claim 3, wherein the energy storage device comprises a battery.

5. The charging stand of claim 3, wherein the energy storage device comprises a capacitive storage device.

6. The charging stand of claim 3, wherein the receiver circuit the transmitter circuit are operated in accordance with a common wireless charging protocol.

7. The charging stand of claim 3, wherein the receiver circuit is operated in accordance with a first wireless charging protocol and the transmitter circuit is operated in accordance with a second wireless charging protocol, wherein the first wireless charging protocol is different from the second wireless charging protocol.

8. The charging stand of claim 3, further comprising:
a sensor configured to detect whether the chargeable device is mounted on the support; and
a controller coupled to the sensor and configured to:
power-down one or more circuits of the power transfer circuit when the sensor indicates that the chargeable device is not mounted on the support; and
power-up the one or more circuits of the power transfer circuit when the sensor indicates that the chargeable device is mounted on the support.

9. The charging stand of claim 8, further comprising:
a switch configured to couple the energy storage device to a transmitter circuit when the one or more circuits of the charging stand are powered-up,
wherein the transmitter circuit is configured to provide the charging current to the transmitting coil.

10. The charging stand of claim 1, wherein the chargeable device comprises a watch, and wherein the support is configured to align the transmitting coil parallel to a back surface of the watch when the chargeable device is mounted on the support.

11. A power transfer method comprising:
configuring a receiver circuit in a base of a charging stand to receive power from a wireless charging device through a receiving coil provided in the base;
configuring a transmitting coil in a support of the charging stand to transmit power to a chargeable device mounted on the support; and
configuring a power transfer circuit to receive an induced current from the receiving coil of the base and to provide a charging current to the transmitting coil of the support.

12. The power transfer method of claim 11, wherein the power transfer circuit comprises an impedance matching network that couples the receiving coil to the transmitting coil in the support.

13. The power transfer method of claim 11, further comprising:
configuring an energy storage device to receive the induced current or a rectified current derived from the induced current; and
configuring a transmitter circuit to use the rectified current or a current output by the energy storage device to provide the charging current to the transmitting coil.

14. The power transfer method of claim 13, wherein the energy storage device comprises a battery.

15. The power transfer method of claim 13, wherein the energy storage device comprises a capacitive storage device.

16. The power transfer method of claim 13, wherein the receiver circuit the transmitter circuit are operated in accordance with a common wireless charging protocol.

17. The power transfer method of claim 13, wherein the receiver circuit is operated in accordance with a first wireless charging protocol and the transmitter circuit is operated in accordance with a second wireless charging protocol, wherein the first wireless charging protocol is different from the second wireless charging protocol.

18. The power transfer method of claim 13, further comprising:
configuring a sensor to detect whether the chargeable device is mounted on the support; and
powering-down one or more circuits of the power transfer circuit when the sensor indicates that the chargeable device is not mounted on the support; and
powering-up the one or more circuits of the power transfer circuit when the sensor indicates that the chargeable device is mounted on the support.

19. The power transfer method of claim 18, further comprising:
configuring a switch to couple the energy storage device to a transmitter circuit when the one or more circuits of the charging stand are powered-up,
wherein the transmitter circuit is configured to provide the charging current to the transmitting coil.

20. The power transfer method of claim 11, wherein the chargeable device comprises a watch, and wherein the support is configured to align the transmitting coil parallel to a back surface of the watch when the chargeable device is mounted on the support.
